(19) United States
(12) Patent Application Publication
(10) Pub. No.: US 2004/0166192 A1
(43) Pub. Date: Aug. 26, 2004

(54) Tool for extruding a pipe-shaped melt strand

(76) Inventor: Peter Stommel, Hennef (DE)

Correspondence Address: Pauley Petersen & Erickson, Suite 365, 2800 W. Higgins Road, Hoffman Estates, IL, 60195, US

(21) Appl. No.: 10/727,146

(22) Filed: Dec. 3, 2003

(30) Foreign Application Priority Data
Dec. 4, 2002 (DE) 202 18 760.8
May 13, 2003 (DE) 203 07 412.2

(51) Int. Cl. B29C 47/24

(52) U.S. Cl. 425/382.4

(57) ABSTRACT

A tool for extruding a pipe-shaped melt strand of thermoplastic material, having a ring-shaped outlet nozzle and at least one melt conduit leading from an associated inlet opening to the outlet nozzle, which extends concentrically with respect to the center axis of the tool and into whose peripheral wall spirally turning helices are cut and form a helical manifold extending in the outlet direction of the melt strand. The helices are cut into the inner peripheral wall and into the outer peripheral wall of the at least one melt conduit.

### BACKGROUND OF THE INVENTION

1. Field of the Invention

This invention relates to a tool for extruding a pipe-shaped melt strand of thermoplastic material, having a ring-shaped outlet nozzle and at least one melt conduit leading from an associated inlet opening to the outlet nozzle, which extends concentrically with respect to the center axis of the tool and into a peripheral wall of which spirally turning helices are cut and form a helical manifold extending in an outlet direction of the melt strand.

2. Discussion of Related Art

A tool is known, for example, from German Patent References DE 44 07 060 A1 and DE 39 25 042 A1.

One main problem in connection with the construction of tools for extruding a pipe-shaped melt strand made of a thermoplastic material, for example for producing blown film, is the production of an even distribution of the melt, starting at the inlet opening of the melt, within the tool, so that subsequently a melt strand, which is evened out over its circumference, emerges from the ring-shaped outlet nozzle. If fluctuations in the flow of the mass occur, then there are fluctuations in the thickness of the film obtained, which should be avoided under all circumstances. Thus, so-called helical distribution devices with spirally turning helices are employed in the melt conduits, for achieving in the tool an even distribution of the melt entering through the inlet opening in the direction toward the outlet nozzle.

With the known tools, these helices in the form of spirally turning grooves are customarily formed in the area of the peripheral wall, which lies on the inside of the melt conduit in relation to the center axis of the tool. Because the helical distribution device assembled in this way by individual helices extends substantially in the extrusion direction, and thus in the exit direction of the melt strand, which is normally vertically oriented from the bottom to the top, this is called a vertical melt manifold.

Furthermore, manifold devices for a plastic melt between the inlet opening and the outlet nozzle have also variously been proposed, which extend transversely with respect to the extrusion and outlet direction of the melt and from there customarily in a horizontal direction, which is generally called a horizontal distribution, such as discussed by U.S. Pat. No. 3,809,515. However, such horizontal distributions are more elaborate in their production and also require a larger structural space in comparison to the known vertical melt distributors.

### SUMMARY OF THE INVENTION

It is one object of this invention to provide a tool of a type in accordance with the species with a vertical melt distribution with respect to the film quality to be obtained, and to prevent the appearance of film contamination because of uneven distribution of the plasticizer, which has been inevitable.

To achieve this object, this invention has a further development of a tool wherein helices are cut into the inner peripheral wall, as well as into the outer peripheral wall, of the at least one melt conduit.

Advantageous embodiments and further developments of the tool in accordance with this invention are discussed in this specification and in the claims.

Depending on the type of melt to be processed and the production parameters, the helices can be embodied in a semi-circular, or approximately semi-circular shape, when viewed in cross section.

The helices cut into the inner peripheral wall and into the outer peripheral wall of a melt conduit can either be placed congruently opposite each other or can be arranged offset with respect to each other in the exit direction, which is a function of the respective Theological properties of the thermoplastic material to be processed.

The depth of the helices can also decrease, starting from the inlet opening in the direction toward the outlet nozzle.

The tool in accordance with this invention can be embodied as a single-layer tool for producing a single-layer, pipe-shaped melt strand, for example for blown film production, wherein it only has a single melt conduit with an associated helical manifold.

In accordance with this invention, in one embodiment the tool is a multi-layer tool that has a plurality of melt conduits leading to the outlet nozzle, which are arranged concentrically with respect to each other and have the respectively associated helical manifolds, wherein the helices are cut into the inner peripheral wall, as well as into the outer peripheral wall, of the respective melt conduit. In accordance with the tool of this invention, all melt conduits are brought together at one location in the tool and thereafter communicate with the outlet nozzle.

### BRIEF DESCRIPTION OF THE DRAWINGS

Further details and embodiments of this invention are apparent from the drawings, wherein:

FIG. 1 is a vertical section view taken through a tool in accordance with one embodiment of this invention;

FIG. 2 shows a portion of the tool as shown in FIG. 1 but on an enlarged scale; and

FIGS. 3 to 5 show various embodiments of a helical manifold employed in a tool in accordance with this invention, in an enlarged detailed view in each of three areas labeled with an X, as shown in FIG. 2.

### DESCRIPTION OF PREFERRED EMBODIMENTS

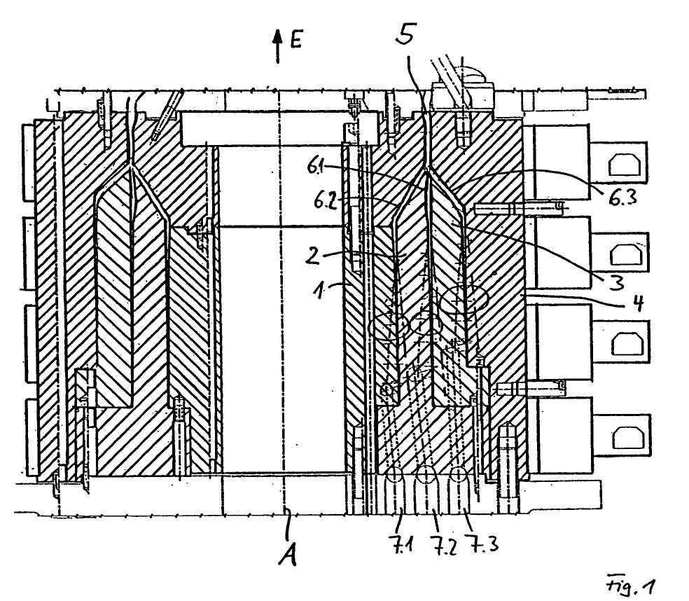

A tool for extruding a pipe-shaped melt strand of thermoplastic material, for example for producing a blown film, is shown in FIG. 1 in a longitudinal section view taken along its center axis A. The tool is shown as a multi-layer tool, in this case as a triple-layer tool, and in a manner known per se comprises an inner mandrel 1, which is surrounded on an exterior by an inner manifold insert 2, with a first melt conduit 6.1 left free. Adjoining the inner manifold insert 2 on its exterior, there is an outer manifold insert 3, wherein a second melt conduit 6.2 is formed between the inner manifold insert 2 and the outer manifold insert 3. Finally, the boundary of the tool on the exterior is provided by an exterior jacket 4, wherein a third melt conduit 6.3 remains between the outer manifold insert 3 and the exterior jacket 4.

From the direction of the underside of the tool, the melt conduits 6.1. 6.2, 6.3 are supplied via respective inlet openings 7.1, 7.2, 7.3 with a melt of thermoplastic material from an extrusion installation, not shown. The melt conduits 6.1, 6.2, 6.3 conduct the melt provided to them via the inlet openings 7.1, 7.2, 7.3 upward in a vertical direction to a ring-shaped outlet opening 5 formed on the top of the tool, from which finally the entire melt emerges in a manner known per se in an extrusion, or outlet, direction E in the form of a pipe-shaped melt strand.

The melt conduits 6.1,6.2, 6.3 are arranged concentrically with respect to the vertically extending center axis A of the tool, the same as the parts of the tool which border them, namely the inner mandrel 1, the inner manifold insert 2, the outer manifold insert 3 and the exterior jacket 4.

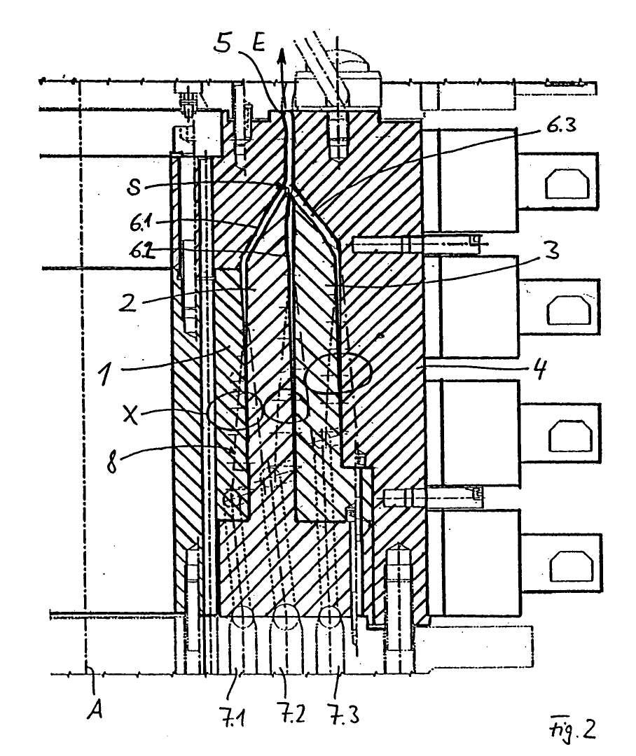

As shown in the enlarged representation in FIG. 2, all melt conduits 6.1, 6.2, 6.3, each of which conducts a layer of the multi-layered melt strand emerging from the pipe-shaped outlet nozzle 5, are brought together at a location S inside the tool and are united into a multi-layered melt strand, which then emerges from the ring-shaped outlet opening 5 in the outlet direction E. Bringing together all melt conduits 6.1, 6.2, 6.3 at a location S in the tool makes possible a high degree of consistency of the multi-layered film obtained. If there is limited space availability, it is also possible to provide as tightly as possible a bringing together of the individual melt conduits 6.1, 6.2, 6.3 following each other in the outlet direction E, in order to come as close as possible to the ideal of bringing together the melt conduits 6.1, 6.2, 6.3 at a location S, as shown in FIG. 2.

FIG. 2 also shows that the melt streams, which initially enter through the inlet openings 7.1, 7.2, 7.3, terminate in respectively one helical manifold 8 extending in the outlet direction of the melt strand, in which the melt, starting at the inlet opening, is distributed as evenly as possible over the entire circumference of the respective melt conduit 6.1, 6.2, 6.3 in order to obtain an even layer thickness over the entire outlet gap of the outlet nozzle 5.

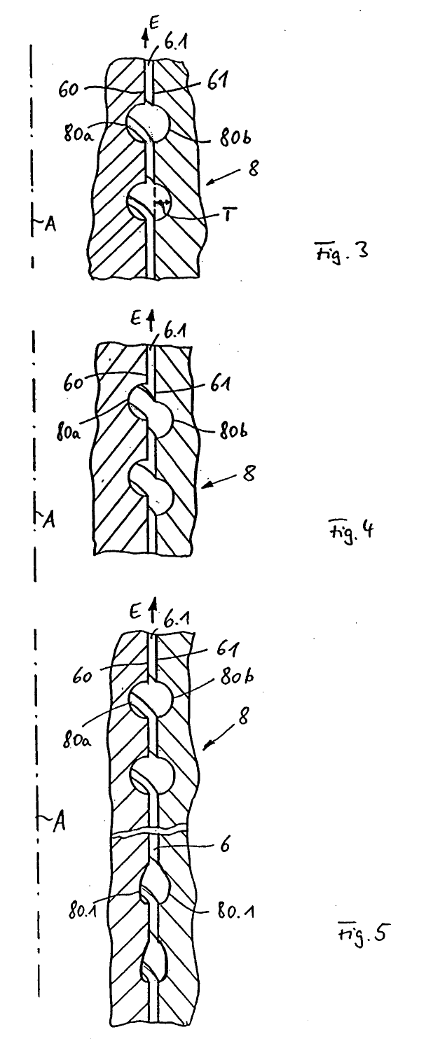

FIG. 3 shows in an enlarged representation the detail X of such a helical manifold 8 in accordance with FIG. 2, a melt conduit 6.1 is shown by example, in which the melt entering from the inlet opening 7.1 is conveyed in the direction toward the ring-shaped outlet nozzle 5. Here, the melt conduit 6.1 is bordered in relation to the center axis A on the inside by an inner peripheral wall 60, and on the outside by an outer peripheral wall 61. The following explanations provided in connection with the melt conduit 6.1 analogously also apply to the remaining melt conduits 6.2 and 6.3.

The helical manifold 8 is formed by groove-shaped helices 80a, 80b, which extend spirally around the center axis A of the tool and are cut into the peripheral walls of the melt conduit 6.1 and cause the distribution of the melt over the circumference of the melt conduit.

It is a substantial feature of the helical manifold 8 that the spirally extending helices 80a, 80b forming the helical manifold 8 are cut into the inner peripheral wall 60, as well as into the outer peripheral wall 61 of the melt conduit 6, by which it is possible to significantly improve the distribution of the melt in the melt conduit 6, and wherein the deposition of impurities or the like, which afterward leads to contamination of the exiting pipe-shaped melt strand, is counteracted. The helices cut into the inside and the outside can extend in the same or opposite directions around the center axis A.

In accordance with the embodiment shown in FIG. 3, the helices 80a formed in the inner peripheral wall 60, and the helices 80b formed in the outer peripheral wall 61, are arranged to lie congruently opposite each other.

In an alternate embodiment shown in FIG. 4, the helices 80a formed in the inner peripheral wall 60 can be arranged offset in the outlet direction E with respect to the helices 80b cut into the outer peripheral wall 61.

Also, in a preferred way the helices 80a, 80b have a semi-circular shape, for example within the drawing plane, wherein their depth T, which simultaneously forms the radius of the helices 80a, 80b, can be designed so that they decrease in the direction toward the ring-shaped outlet nozzle 5, starting at the inlet opening 7.1, 7.2, 7.3.

Finally, in the embodiment shown in FIG. 5, besides the helices indicated by the reference numeral 80 and having a semi-circular cross section, it is also possible to provide cross-sectional shapes for helices with outer contours that approach an ellipse, which is shown by the reference symbol 80.1. Other suitable cross-sectional shapes of the helices can also be selected.

Differing from the exemplary embodiments represented, the tool can also have more or fewer melt conduits than the melt conduits 6.1, 6.2, 6.3 shown here. For example, it can be designed as a single-layer tool with only one melt conduit, or as a multi-layer tool with two or more melt conduits.

In the case of its embodiment as a multi-layer tool with more than one melt conduit 6, the bringing together of the melt conduits at a common location S inside the tool is preferred.

German Patent References 203 07 412.2 and 202 18 760.8, the priority documents corresponding to this invention, and its teachings are incorporated, by reference, into this specification.

What is claimed is:

1. A tool for extruding a pipe-shaped melt strand of thermoplastic material, the tool comprising: a ring-shaped outlet nozzle (5) and at least one melt conduit leading (6.1, 6.2, 6.3) from an inlet opening (7.1, 7.2, 73) of the tool to the outlet nozzle (5) which extends concentrically with respect to a center axis (A) of the tool and are cut into a peripheral wall as spirally turning helices and form a helical manifold (8) extending in an outlet direction (E) of the melt strand, and the helices are cut into the inner peripheral wall (60) and into an outer peripheral wall (61) of the at least one melt conduit.

2. The tool in accordance with claim 1, wherein the helices are formed in a semi-circular shape when viewed in cross section.

3. The tool in accordance with claim 2, wherein the helices cut into the inner peripheral wall (60) and into the outer peripheral wall (61) of the melt conduit (6.1, 6.2, 6.3) are positioned congruently opposite each other.

4. The tool in accordance with claim 2, wherein the helices cut into the inner peripheral wall (60) and into the outer peripheral wall (61) of a melt conduit (6.1, 6.2,6.3) are arranged offset with respect to each other in the outlet direction (E).

5. The tool in accordance with claim 4, wherein a depth (T) of the helices decreases, starting from the inlet opening and in a direction toward the outlet nozzle (5).

6. The tool in accordance with claim 5, wherein the tool is a multi-layer tool with a plurality of melt conduits (6.1, 6.2, 6.3) leading to the outlet nozzle (5) and arranged concentrically with respect to each other and with respectively associated helical manifolds (8), wherein the melt conduits (6.1,6.2,6.3) are brought together in one location (S) in the tool and communicate with the outlet nozzle (5).

7. The tool in accordance with claim 1, wherein the helices cut into the inner peripheral wall (60) and into the outer peripheral wall (61) of a melt conduit (6.1, 6.2, 6.3) are positioned congruently opposite each other.

8. The tool in accordance with claim 1, wherein the helices cut into the inner peripheral wall (60) and into the outer peripheral wall (61) of the melt conduit (6.1, 6.2, 6.3) are arranged offset with respect to each other in the outlet direction (E).

9. The tool in accordance with claim 1, wherein a depth (T) of the helices decreases, starting from the inlet opening and in a direction toward the outlet nozzle (5).

10. The tool in accordance with claim 1, wherein the tool is a multi-layer tool with a plurality of melt conduits (6.1, 6.2, 6.3) leading to the outlet nozzle (5) and arranged concentrically with respect to each other and with respectively associated helical manifolds (8), wherein the melt conduits (6.1,6.2, 6.3) are brought together in one location (S) in the tool and communicate with the outlet nozzle (5).
